(19) United States
(12) Patent Application Publication
(10) Pub. No.: US 2016/0343279 A1
(43) Pub. Date: Nov. 24, 2016

(54) DISPLAY DEVICE

(71) Applicant: Panasonic Liquid Crystal Display Co., Ltd., Hyogo (JP)

(72) Inventors: Ryutaro OKE, Hyogo (JP); Masahiro ISHII, Hyogo (JP); Tomohiro NAKAYAMA, Hyogo (JP); Kazuhiro KANAI, Hyogo (JP)

(21) Appl. No.: 15/158,582

(22) Filed: May 19, 2016

(30) Foreign Application Priority Data
May 20, 2015 (JP) 2015-102554

(51) Int. Cl. G09G 3/00; G09G 3/36

(52) U.S. Cl. CPC G09G 3/006; G09G 3/3611; G09G 2320/029

(57) ABSTRACT

Provided is a display device, including: a display panel including a plurality of test transistors each of which is connected to one wiring line selected out of data lines and gate lines, a control signal input pad configured to input a control signal for putting the test transistors into one of an on state and an off state during a test of the display panel, and an off-voltage input terminal configured to input an off voltage for fixing the plurality of test transistors to the off state during display operation;

gate driver ICs provided outside the display panel; a gate driver external circuit board to which the gate driver ICs are electrically connected; and off-voltage input wiring through which the off voltage is input to the off-voltage input terminal, in which the off-voltage input wiring is electrically connected to the off-voltage input terminal via the gate driver external circuit board.

### CROSS-REFERENCE TO RELATED APPLICATION

The present application claims priority from Japanese application JP 2015-102554 filed on May 20, 2015, the content of which is hereby incorporated by reference into this application.

### BACKGROUND

1. Technical Field

This application relates to a display device.

2. Description of the Related Art

Tape Carrier Package (TCP) and Chip on Film (COF) have been employed as methods of packaging a plurality of gate driver ICs and source driver ICs that are arranged in a peripheral portion of a display panel. In TCP and COF, for example, driver ICs provided outside a display panel are electrically connected to the display panel via an external circuit board, a film, or the like.

Hitherto, there has also been proposed a testing method for detecting a wiring defect in a gate line, a data line, or other wiring lines in a display panel to which an external circuit board is connected (see Japanese Patent Application Laid-open No. 2010-139962, for example).

A display panel disclosed in Japanese Patent Application Laid-open No. 2010-139962 includes a connection pad for connecting the external circuit board, and a test pad arranged on the opposite side from the side where the connection pad is placed. The detection of a defect in this display panel involves pressing the tip of a test probe to the test pad, which forms an electric contact, and thus checking a wiring line for electrical continuity.

### SUMMARY

The definition enhancement and size reduction of display panels in recent years are making the gap between adjacent wiring lines narrower. When a display panel as this employs the configuration of the related art described above, the test probe comes into contact with adjacent wiring lines simultaneously, which hinders an accurate test, and thus is a problem.

The present application has been made in view of the problem described above, and an object of the present application is therefore to provide a display device, which includes a display panel electrically connected to external driver ICs, and is capable of testing the display panel without fail.

In order to solve the problem described above, according to one embodiment of this application, there is provided a display device, including: a display panel including a plurality of data lines, a plurality of gate lines, a plurality of test transistors each of which is connected to one wiring line selected out of the plurality of data lines and the plurality of gate lines, a control signal input pad configured to input a control signal for putting the plurality of test transistors into one of an on state and an off state during a test of the display panel, and an off-voltage input terminal configured to input an off voltage for fixing the plurality of test transistors to the off state during display operation; gate driver ICs provided outside the display panel; a gate driver external circuit board to which the gate driver ICs are electrically connected; and off-voltage input wiring through which the off voltage is input to the off-voltage input terminal, in which the off-voltage input wiring is electrically connected to the off-voltage input terminal via the gate driver external circuit board.

The display device according to one embodiment of this application, further including films on which the gate driver ICs are mounted, in which the display panel and the gate driver external circuit board may be electrically connected to each other via the films.

The display device according to one embodiment of this application, in which the off-voltage input wiring may be electrically connected to the off-voltage input terminal further via the films.

The display device according to one embodiment of this application, in which the display panel may further include: off-voltage transmission wiring including one end electrically connected to the off-voltage input terminal and another end electrically connected to the control signal input pad; and test control signal supply wiring including one end electrically connected to the control signal input pad and another end electrically connected to respective control electrodes of the plurality of test transistors.

The display device according to one embodiment of this application, in which the off-voltage transmission wiring and the test control signal supply wiring may be formed in the same layer.

The display device according to one embodiment of this application, in which the off-voltage transmission wiring may be laid along an outermost edge of the display panel.

The display device according to one embodiment of this application, in which the off-voltage transmission wiring may be laid so as to avoid overlapping with other wiring lines in plan view.

### BRIEF DESCRIPTION OF THE DRAWINGS

FIG. 1 is a plan view for illustrating a schematic configuration of a liquid crystal display device according to an embodiment of this application.

FIG. 2 is a plan view for illustrating a schematic configuration of a display panel according to this embodiment.

FIG. 3 is a plan view for illustrating a detailed configuration of the display panel according to this embodiment.

### DETAILED DESCRIPTION

An embodiment of the present application is described below with reference to the drawings. The embodiment of the present application takes a liquid crystal display device as an example of a display device of the present application. However, the present application is not limited thereto and the display device can be an organic EL display device, for example. While the liquid crystal display device given as an example in the embodiment of the present application is of the COF type, the present application is not limited thereto and a TCP liquid crystal display device, for example, maybe used instead. The liquid crystal display device according to this embodiment specifically has a configuration in which driver ICs (source driver ICs, gate driver ICs, and the like) provided outside a display panel are mounted on an external circuit board and films, and are electrically connected to the display panel via at least one of the external circuit board and the films.

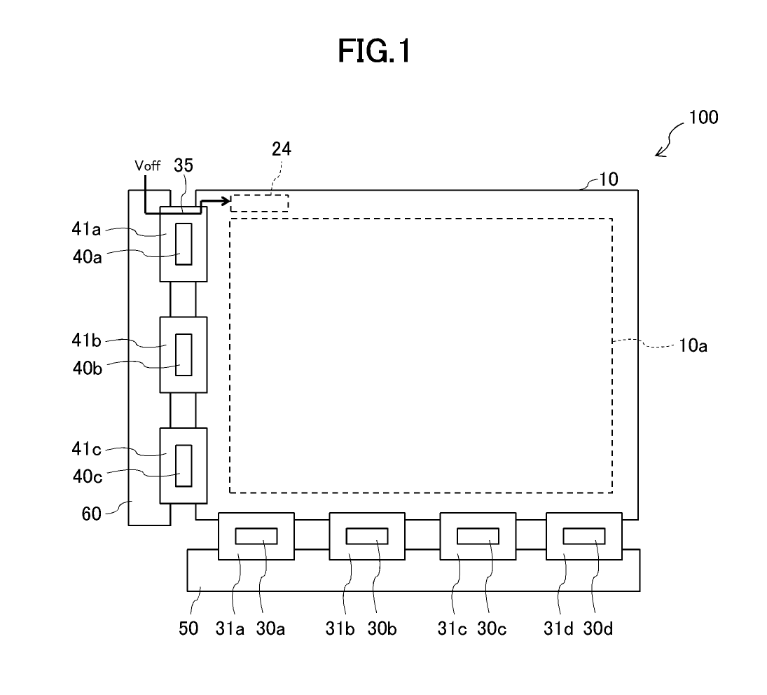

FIG. 1 is a plan view for illustrating a schematic configuration of the liquid crystal display device according to this embodiment. A liquid crystal display device 100 includes a display panel 10, source driver ICs 30a, 30b, 30c, and 30d, source driver COFs 31a, 31b, 31c, and 31d, gate driver ICs 40a, 40b, and 40c, gate driver COFs 41a, 41b, and 41c, a source driver external circuit board 50, a gate driver external circuit board 60, and a backlight unit (not shown). The source driver IC 30a is mounted on the source driver COF 31a, the source driver IC 30b is mounted on the source driver COF 31b, the source driver IC 30c is mounted on the source driver COF 31c, and the source driver IC 30d is mounted on the source driver COF 31d. The gate driver IC 40a is mounted on the gate driver COF 41a, the gate driver IC 40b is mounted on the gate driver COF 41b, and the gate driver IC 40c is mounted on the gate driver COF 41c. The number of the source driver ICs 30 and the number of the gate driver ICs 40 are not limited. The source driver ICs 30 and the gate driver ICs 40, which are aligned separately from each other along two different sides of the display panel 10 in FIG. 1, may both be aligned along one side of the display panel 10. The display panel 10 includes a display region 10a and a frame region around the display region 10a. Although not shown, a timing controller configured to control the operation of the source driver ICs 30 and the gate driver ICs 40 may be mounted on the source driver external circuit board 50 or the gate driver external circuit board 60.

The display panel 10 and the source driver external circuit board 50 are electrically connected to each other via the source driver COFs. The display panel 10 and the gate driver external circuit board 60 are electrically connected to each other via the gate driver COFs.

A test signal input pad 24 is provided in a peripheral portion of the display panel 10 (in FIG. 1, an upper left end portion of the display panel 10). Test equipment is connected to the test signal input pad 24. Gate off-voltage input wiring 35 (off-voltage input wiring) is also electrically connected to the test signal input pad 24. The gate off-voltage input wiring 35 is laid on the gate driver external circuit board 60 and the gate driver COF 41a. A gate off-voltage Voff is input to the test signal input pad 24 via the gate off-voltage input wiring 35. Details of the test signal input pad 24 and the gate off-voltage input wiring 35 are described later.

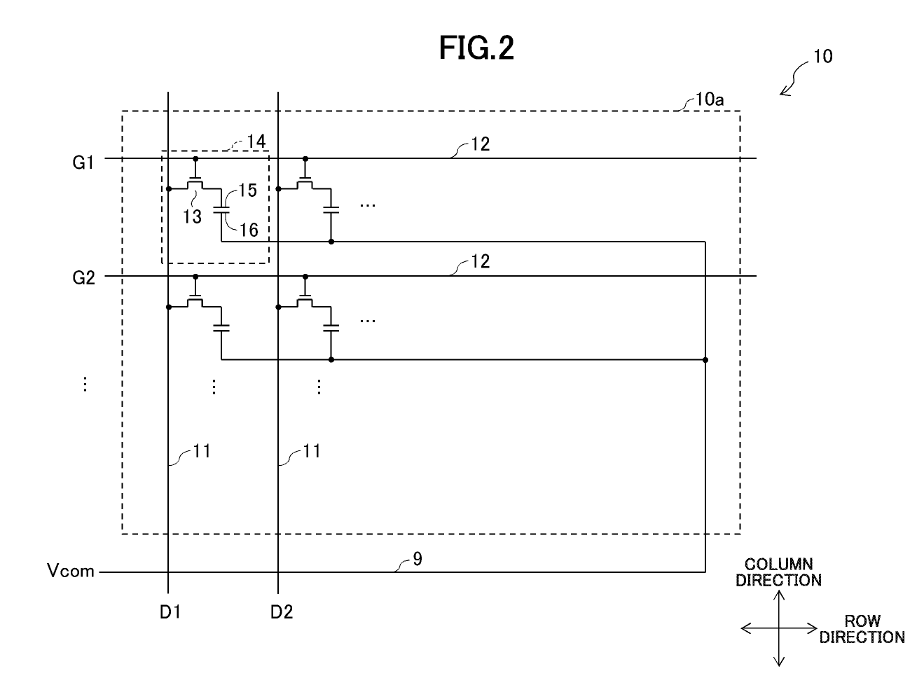

FIG. 2 is a plan view for illustrating a schematic configuration of the display device 10. The display panel 10 includes a plurality of data lines 11 extending in a column direction, and a plurality of gate lines 12 extending in a row direction.

A thin film transistor 13 (TFT) is formed at each intersecting portion between each data line 11 and each gate line 12. Each data line 11 is electrically connected to the source driver IC 30. Each gate line 12 is electrically connected to the gate driver IC 40.

The display panel 10 includes a plurality of pixels 14 arranged in matrix (in the row direction and the column direction) so as to correspond to each intersecting portion between each data line 11 and each gate line 12. Note that, although not shown, the display panel 10 includes a thin film transistor substrate (TFT substrate), a color filter substrate (CF substrate), and a liquid crystal layer sandwiched between both the substrates. The TFT substrate includes a plurality of pixel electrodes 15 arranged so as to correspond to the respective pixels 14. The CF substrate includes a common electrode 16 common to the respective pixels 14. Note that, the common electrode 16 may be formed on the TFT substrate.

Each data line 11 is supplied with a data signal (data voltage) from the corresponding source driver IC 30. Each gate line 12 is supplied with a gate signal (gate voltage) from the corresponding gate driver IC 40. The common electrode 16 is supplied with a common voltage Vcom via common wiring 9. When an on voltage of the gate signal (gate on-voltage) is supplied to the gate line 12, the thin film transistor 13 connected to the gate line 12 is turned on so that the data voltage is supplied to the pixel electrode 15 via the data line 11 connected to the thin film transistor 13. An electric field is generated by the difference between the data voltage supplied to the pixel electrode 15 and the common voltage Vcom supplied to the common electrode 16. This electric field is used to drive the liquid crystal and control the transmittance of light from the backlight unit. In this manner, an image is displayed. Note that, in the case of color display, the color display is realized by supplying desired data voltages to the data lines 11 connected to the respective pixel electrodes 15 of the pixels 14 corresponding to respective red color, green color, and blue color formed of stripe-shaped color filters.

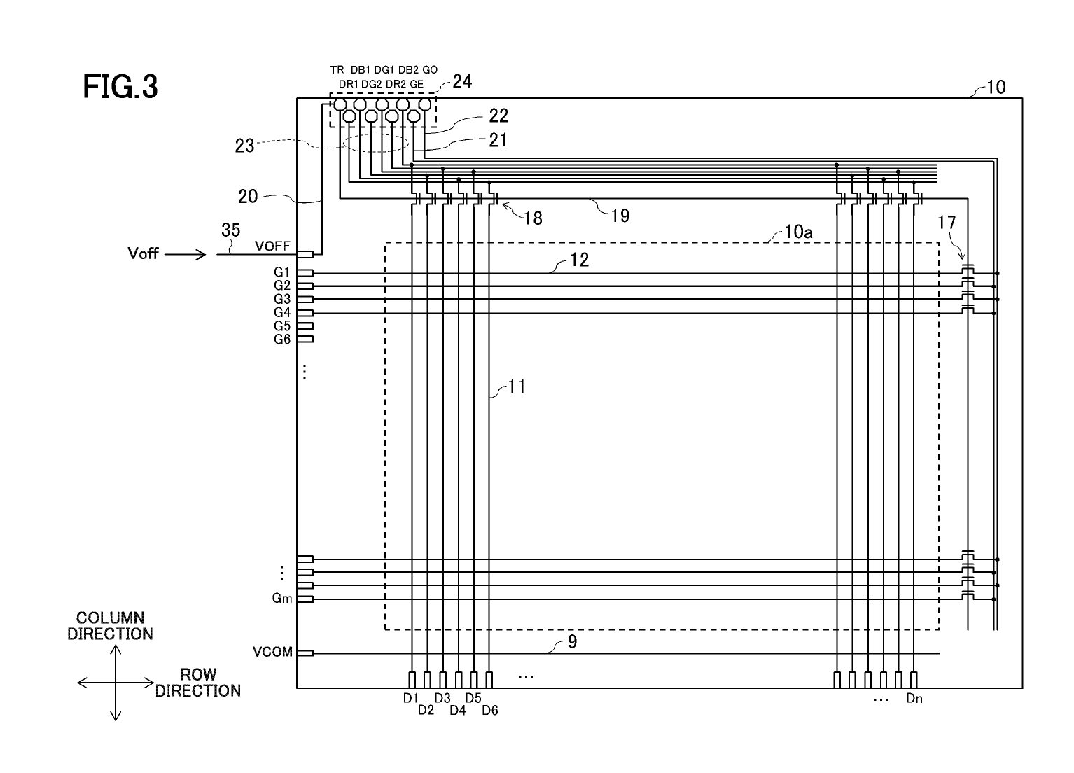

FIG. 3 is a plan view for illustrating a detailed configuration of the display panel 10. Terminals G1 to Gm, terminals D1 to Dn, and a terminal VCOM are arranged in a peripheral portion of the frame region of the display panel 10 (in FIG. 3, a left end portion of the display panel 10). The gate lines 12 have one ends connected to the terminals G1 to Gm. The data lines 11 have one ends connected to the terminals D1 to Dn. One end of common wiring 9 through which the common voltage Vcom is supplied to the common electrode 16 is connected to the terminal VCOM.

The liquid crystal display device 100 has a configuration for detecting a defect in the display panel 10, for example, a wiring breakage in the data lines 11 and the gate lines 12. Details of this configuration are described below.

The display panel 10 includes a plurality of test transistors 17 having conducting electrodes (source/drain electrodes) connected to the gate lines 12, a plurality of test transistors having conducting electrodes (source/drain electrodes) connected to the data lines 11, test control signal supply wiring 19 through which control electrodes (gate electrodes) are supplied with test control signals for controlling the turning on/off of the test transistors 17 and 18, test gate signal supply wiring 21 through which test gate signals Ge (a gate on-voltage and a gate off-voltage) are supplied to the conducting electrodes of the test transistors 17 that are in even-numbered rows, test gate signal supply wiring 22 through which test gate signals Go (a gate on-voltage and a gate off-voltage) are supplied to the conducting electrodes of the test transistors 17 that are in odd-numbered rows, and a plurality of (here, six) test data signal supply wiring lines 23 through which test data signals Dr1, Dg1, Db1, Dr2, Dg2, and Db2 are supplied to the conducting electrodes of the test transistors 18. One test transistor 17 is connected to each gate line 12, and one test transistor 18 is connected to each data line 11. A terminal VOFF (off-voltage input terminal) through which the gate off-voltage Voff is input to the display panel 10 from the outside is provided in the peripheral portion of the frame region of the display panel 10 (in FIG. 3, an upper left end portion of the display panel 10). The terminal VOFF is aligned with the terminals G1 to Gm along one side of the display panel 10.

The control electrodes of all of the test transistors 17 and the test transistors 18 are connected to a single test control signal supply wiring line 19. The test control signal supply wiring 19 is connected to a control signal input pad TR, which is arranged in the peripheral portion of the display panel 10. When a test control signal is supplied to the test control signal supply wiring 19 from the outside via the control signal input pad TR, the test transistors 17 and 18 are all turned on or off at once. The test gate signal supply wiring 21 is connected to a gate signal input pad GE, which is arranged in the peripheral portion of the display panel 10. The test gate signal supply wiring 22 is connected to a gate signal input pad GO, which is arranged in the peripheral portion of the display panel 10. The test gate signal supply wiring 21 is connected via a plurality of test transistors 17 that are in even-numbered rows to a plurality of gate lines 12 that are in even-numbered rows. The test gate signal supply wiring 22 is connected via a plurality of test transistors 17 that are in odd-numbered rows to a plurality of gate lines 12 that are in odd-numbered rows. When the test transistors 17 are turned on and a test gate signal is supplied to the test gate signal supply wiring 21 from the outside via the gate signal input pad GE, the test gate signal is supplied to the plurality of gate lines 12 that are in even-numbered rows via the test transistors 17 that are in even-numbered rows. When the test transistors 17 are turned on and a test gate signal is supplied to the test gate signal supply wiring 22 from the outside via the gate signal input pad GO, the test gate signal is supplied to the plurality of gate lines 12 that are in odd-numbered rows via the test transistors 17 that are in odd-numbered rows.

The plurality of test data signal supply wiring lines 23 are connected respectively to data signal input pads DR1, DG1, DB1, DR2, DG2, and DB2, which are arranged in the peripheral portion of the display panel 10. For example, when the test transistors 18 are turned on and a test data signal for red (R) pixels is supplied to the test data signal supply wiring lines 23 from the outside via the data signal input pad DR1, the test data signal for R pixels is supplied to a plurality of corresponding data lines 11 via the test data signal supply wiring line 23 and the test transistor 18 that are connected to the data signal input pad DR1. When the test transistors 18 are turned on and a test data signal for green (G) pixels is supplied to the test data signal supply wiring lines 23 from the outside via the data signal input pad DG1, the test data signal for G pixels is supplied to a plurality of corresponding data lines 11 via the test data signal supply wiring line 23 and the test transistor 18 that are connected to the data signal input pad DG1. For each pixel color, a test data signal for pixels of the color is similarly supplied to the data lines 11 that are associated with the color. In the example of FIG. 3, every sixth data line 11 out of the plurality of data lines 11 is connected to the same test data signal supply wiring line 23.

The pads described above are included in the test signal input pad 24, which is arranged in the peripheral portion of the display panel 10 (in FIG. 3, an upper left end portion of the display panel 10). Test equipment is connected to the test signal input pad 24 and various test signals are input from the test equipment to the test signal input pad 24.

To conduct a test of the display panel 10, test equipment is connected to the test signal input pad 24 in, for example, a test step that is included in a manufacturing process of the display panel 10, and various test signals are supplied to the respective test signal supply wiring lines via the test signal input pad 24. Specifically, the test equipment supplies test control signals for controlling the turning on/off of the test transistors 17 and 18 to the test control signal supply wiring 19, supplies the test gate signals Ge to the test gate signal supply wiring 21, supplies the test gate signals Go to the test gate signal supply wiring 22, and supplies the test data signals Dr1, Dg1, Db1, Dr2, Dg2, and Db2 respectively to the plurality of test data signal supply wiring lines 23.

After the test step is finished, the test equipment is disconnected from the test signal input pad 24. Disconnecting the test equipment from the display panel 10 puts the test transistors 17 and 18 in an electrically floating state. The test transistors 17 and 18 may therefore be turned on accidentally while the display device is in use as a finished product (during display operation) due to, for example, the display operation, and a resultant change in pixel potential can cause display troubles. In order to avoid such display troubles, the test transistors 17 and 18 in a floating state need to be fixed to the off state without fail when the display device is in use as a finished product (during display operation). The liquid crystal display device 100 in this embodiment clears this requirement by having a configuration that fixes the test transistors 17 and 18 to the off state without fail when in use as a finished product.

Specifically, the display panel 10 includes gate off-voltage transmission wiring 20 (off-voltage transmission wiring) through which a control signal for turning the test transistors 17 and 18 off (a gate off-voltage) is supplied. The gate off-voltage transmission wiring 20 has one end connected to the terminal VOFF, which is provided in the peripheral portion of the display panel 10 (in FIG. 3, an upper left end portion of the display panel 10), and has the other end connected to the control signal input pad TR. The gate off-voltage transmission wiring 20 is laid along the outermost edge of the display panel 10 as illustrated in FIG. 3. The gate off-voltage transmission wiring 20 is also laid so as not to overlap with (not to intersect with) other wiring lines in plan view. The gate off-voltage transmission wiring 20 is formed in the same layer where other test signal supply wiring lines 19 and 21 to 23 are formed. This wiring layout can prevent short circuit between the gate off-voltage transmission wiring 20 and other wiring lines. The wiring layout also eliminates the need to form a through hole for electrically connecting the gate off-voltage transmission wiring 20 to the test control signal supply wiring 19, and thus helps to reduce the frame region in size.

The gate off-voltage input wiring 35 is connected to the terminal VOFF, which is provided in the display panel 10. The gate off-voltage input wiring 35 is connected to the terminal VOFF via the gate driver external circuit board 60 and one of the gate driver COFs (for example, the gate driver COF 41a) (see FIG. 1 and FIG. 3). A gate off-voltage is applied to the gate off-voltage input wiring 35 constantly during display operation. The display panel 10 can thus be supplied with a gate off-voltage, and the test transistors 17 and 18 can therefore be fixed to the off state during display operation. Existing wiring that is provided in the gate driver external circuit board 60 may be utilized as the gate off-voltage input wiring 35.

An example of a testing method in the liquid crystal display device 100 is described next. Test equipment is connected to the test signal input pad 24 of the display panel 10 first. Next, a test control signal (a gate on-voltage) is input from the test equipment to the test control signal supply wiring 19 via the control signal input pad TR. This turns the test transistors 17 and 18 on. The test gate signal Go that has a gate on-voltage is next input from the test equipment to the conducting electrodes of the test transistors 17 that are in odd-numbered rows. The gate lines 12 that are in odd-numbered rows are selected as a result. Next, the test data signals Dr1, Dg1, Db1, Dr2, Dg2, and Db2 are supplied from the test equipment via the thin film transistors 13 (see FIG. 2) that are connected to the gate lines 12 in odd-numbered rows to the corresponding pixel electrodes 15. The common voltage Vcom is supplied to the common electrode 16. The display state of the corresponding pixels 14, here, the pixels 14 that are in odd-numbered rows, is thus checked, to thereby detect a wiring defect in gate lines, data lines, or other wiring lines that are associated with the checked pixels 14. The test data signal for one pixel color may be supplied at timing different from that of the test data signal for another pixel color.

The test equipment subsequently inputs the test gate signal Go that has a gate off-voltage to the conducting electrodes of the test transistors 17 that are in odd-numbered rows, and inputs the test gate signal Ge that has a gate on-voltage to the conducting electrodes of the test transistors 17 that are in even-numbered rows. As a result, the gate lines 12 that are in odd-numbered rows are no longer selected and the gate lines 12 that are in even-numbered rows are selected. The test equipment next supplies the test data signals Dr1, Dg1, Db1, Dr2, Dg2, and Db2 via the thin film transistors (see FIG. 2) that are connected to the gate lines 12 in even-numbered rows to the corresponding pixel electrodes 15. The common voltage Vcom is supplied to the common electrode 16. The display state of the corresponding pixels 14, here, the pixels 14 that are in even-numbered rows, is thus checked, to thereby detect a wiring defect in gate lines, data lines, or other wiring lines that are associated with the checked pixels 14. After the test step is finished, the test equipment is disconnected from the test signal input pad 24 of the display panel 10. The display panel 10 is tested in the test step in this manner.

The method of testing the display panel 10 is not limited to the one described above, and known methods can be employed.

The liquid crystal display device 100 according to this embodiment is a display device that includes a display panel electrically connected to external driver ICs and that is capable of testing the display panel without fail.

While there have been described what are at present considered to be certain embodiments of the application, it will be understood that various modifications may be made thereto, and it is intended that the appended claims cover all such modifications as fall within the true spirit and scope of the invention.

What is claimed is:

1. A display device, comprising:
a display panel including a plurality of data lines, a plurality of gate lines, a plurality of test transistors each of which is connected to one wiring line selected out of the plurality of data lines and the plurality of gate lines, a control signal input pad configured to input a control signal for putting the plurality of test transistors into one of an on state and an off state during a test of the display panel, and an off-voltage input terminal configured to input an off voltage for fixing the plurality of test transistors to the off state during display operation;
gate driver ICs provided outside the display panel;
a gate driver external circuit board to which the gate driver ICs are electrically connected; and
off-voltage input wiring through which the off voltage is input to the off-voltage input terminal,
wherein the off-voltage input wiring is electrically connected to the off-voltage input terminal via the gate driver external circuit board.

2. The display device according to claim 1, further comprising films on which the gate driver ICs are mounted,
wherein the display panel and the gate driver external circuit board are electrically connected to each other via the films.

3. The display device according to claim 2, wherein the off-voltage input wiring is electrically connected to the off-voltage input terminal further via the films.

4. The display device according to claim 1, wherein the display panel further includes:
off-voltage transmission wiring including one end electrically connected to the off-voltage input terminal and another end electrically connected to the control signal input pad; and
test control signal supply wiring including one end electrically connected to the control signal input pad and another end electrically connected to respective control electrodes of the plurality of test transistors.

5. The display device according to claim 4, wherein the off-voltage transmission wiring and the test control signal supply wiring are formed in the same layer.

6. The display device according to claim 4, wherein the off-voltage transmission wiring is laid along an outermost edge of the display panel.

7. The display device according to claim 4, wherein the off-voltage transmission wiring is laid so as to avoid overlapping with other wiring lines in plan view.
